(19) United States
(12) Patent Application Publication
(10) Pub. No.: US 2018/0314093 A1
(43) Pub. Date: Nov. 1, 2018

(54) ARRAY SUBSTRATE, METHOD OF MANUFACTURING THE SAME AND IN CELL TOUCH CONTROL DISPLAY PANEL

(71) Applicant: Wuhan China Star Optoelectronics Technology Co., Ltd., Wuhan City (CN)

(72) Inventor: Yafeng Li, Wuhan City (CN)

(21) Appl. No.: 15/529,513

(22) PCT Filed: Mar. 15, 2017
(86) PCT No.: PCT/CN2017/076774

§ 371 Date: May 25, 2017

(30) Foreign Application Priority Data
Feb. 17, 2017 (CN) 201710087024.9

(51) Int. Cl. G02F 1/1333; G02F 1/1368; G02F 1/1362; G02F 1/1339; G02F 1/1335; G06F 3/041

(52) U.S. Cl. CPC G02F 1/13338; G02F 1/1368; G02F 1/136227; G02F 1/136209; G02F 1/13394; G02F 1/134363; G02F 1/133514; G06F 3/0412; G02F 2001/13685; G02F 2202/104; G02F 1/133345

(57) ABSTRACT

The present invention provides an array substrate, a method of manufacturing the same and an In Cell touch control display panel. The array substrate of the present invention, by sequentially forming the first flat layer, the touch control signal layer, the second flat layer, the common electrode, the passivation layer, and pixel electrode on the source/drain electrode, the data line and the third insulating layer, such an architecture of which makes the touch control signal layer located under the second flat layer, would not be present in a manner that a region of a surface of the array substrate corresponding to the touch control signal layer forms protrusion, and a surface of said array substrate gets flatter so as to prevent the spacer from sliding to cause a manner of liquid crystal cell collapsing or alignment film scratching, promoting display quality; simultaneously, and makes three passivation layers of the conventional array substrate reduced into one passivation layer, and thereby simplifies manufacturing process, lower manufacturing process cost. In the manufacturing method of the array substrate of the present invention, the manufactured array substrate has a flatter surface, and a simplified manufacturing process, manufacturing process cost. The In Cell touch control display panel of the present invention has a great display quality, and a lower production cost, simultaneously.

### FIELD OF THE INVENTION

The present invention relates to a display technology field, and more particular to, an array substrate, a method of manufacturing the same and in cell touch control display panel.

### BACKGROUND OF THE INVENTION

Along with rapid development of the display technology, the touch control display panels have been widely acceptable and consumed for people, e.g. a smart phone, a tablet computer and so forth all employ the touch control display panel. The touch control display panel adopts an embedded touch control technology to combine touch control panel and liquid crystal display panel in an integral, and to embed a touch control panel function to a liquid crystal display panel, whereby the liquid crystal display panel has functions for displaying and sensing touch control input at the same time. According to its different structures, the touch control display panels can be divided into, a type of touch control electrodes covering on a liquid crystal cell (On Cell), a type of touch control electrodes embedded inside a liquid crystal cell (In Cell), and an Add On type, wherein the in cell touch control display panel has advantages in low cost, super thin and narrow frame, which is primarily applied for high-end touch control product, and evolutes to be a primary direction of developing the touch control technology in the future.

Please refer to FIG. 1 and FIG. 2, which are cross-sectional view schematic diagrams of a conventional in cell touch control display panel. Said In Cell touch control display panel comprises a array substrate 100, a color film substrate 200 disposed relative to said array substrate 100, and a liquid crystal layer 300 located between said array substrate 100 and the color film substrate 200;

Said array substrate 100 comprises a first substrate 110, a light-shielding layer 120 disposed on said first substrate 110, a first insulating layer 130 disposed on said first substrate 110 and the light-shielding layer 120, a polysilicon layer 140 disposed on said first insulating layer 130, a second insulating layer 150 disposed on said first insulating layer 130 and the polysilicon layer 140, a gate electrode 160 disposed on said second insulating layer 150, a third insulating layer 170 disposed on said gate electrode 160 and the second insulating layer 150, a source/drain electrode 410 and a data line 420 disposed on said third insulating layer 170, a flat layer 500 disposed on said source/drain electrode 410, the data line 420 and the third insulating layer 170, a first passivation layer 810 disposed on said flat layer 500, a touch control signal layer 600 disposed on said first passivation layer 810, a second passivation layer 820 disposed on said touch control signal layer 600 and the first passivation layer 810, a common electrode 700 disposed on said second passivation layer 820, a third passivation layer 830 disposed on said common electrode 700 and the second passivation layer 820, and a pixel electrode 900 disposed on said third passivation layer 830;

As shown in FIG. 1, said third passivation layer 830, the second passivation layer 820, the first passivation layer 810 and the flat layer 500 are disposed with a first via hole 910, and said pixel electrode 900 and the source/drain electrode 410 mutually contact with each other by said first via hole 910; as shown in FIG. 2, a second via hole 920 is disposed on said second passivation layer 820, and said common electrode 700 and the touch control signal layer 600 mutually contact with each other by said second via hole 920;

said color film substrate 200 is disposed with spacer 250 which contacts with a surface of said array substrate 100, mutually.

Manufacturing method for said array substrate 100 is that:

step 1′, providing the first substrate 110 which bottom-to-top sequentially forms thereon the light-shielding layer 120, the first insulating layer 130, the polysilicon layer 140, the second insulating layer 150, the gate electrode 160, the third insulating layer 170, the source/drain electrode 410 and the data line 420;

step 2′, forming the flat layer 500 on said source/drain electrode 410, the data line 420 and the third insulating layer 170, forming the first passivation layer 810 on said flat layer 500, forming the control signal layer 600 on said first passivation layer 810, and forming the second passivation layer 820 on said touch control signal layer 600 and the first passivation layer 810;

applying a photolithography process to etch said flat layer 500, the first passivation layer 810 and the second passivation layer 820, in a manner of forming a first through aperture 913 on said flat layer 500, the first passivation layer 810 and the second passivation layer 820 and with corresponding to an upper of the said source/drain electrode 410, and forming the second via hole 920 on said second passivation layer 820 and with corresponding to an upper of said touch control signal layer 600, simultaneously;

step 3′, forming the common electrode 700 on said second passivation layer 820 to mutually contact with the touch control signal layer 600 by said second via hole 920;

step 4′, forming the third passivation layer 830 on said common electrode 700 and the second passivation layer 820, applying a photolithography process to etch the third passivation layer 830 where a second through aperture 914 communicated with said first through aperture 913 is formed, and said second through aperture 914 and the first through aperture 913 constitute the first via hole 910;

step 5′, forming the pixel electrode 900 on said third passivation layer 830 to mutually contact with the source/drain electrode 410 by said first via hole 910.

From the structure of said array substrate 100 and the method of manufacturing the same, it can be seen that, since said array substrate 100 has total amount of three passivation layers consisting of the first passivation layer 810, the second passivation layer 820, and the third passivation layer 830, this makes its manufacturing process complicated and its process cost increased;

Besides, since the touch control signal layer 600 gets thicker and located above the flat layer 500, said array substrate 100 has a surface where a region corresponding to said touch control signal layer 600 forms thereon a protrusion 101, whereas with a limitation of the space, the region is commonly as a contact region of the spacer 250 and the array substrate 100, such that while an offset or a sliding occurs between the array substrate 100 and the color film substrate 200, the spacer 250 is readily slide down to the lower of said protrusion 101, this easily leads to change of a liquid crystal cell thickness (Cell Gap), bringing a poor display; and while the spacer 250 is presented in sliding, it readily results in scratching alignment film (not shown) of the region, tiny and bit highlights, and affecting display quality of the panel.

### SUMMARY OF THE INVENTION

An objective of the present invention is to provide an array substrate, of which a surface gets flatter, with capabilities of preventing spacer from sliding to cause a manner of liquid crystal cell collapsing or alignment film scratching, and thereby promoting display quality, and lowering manufacturing process cost, simultaneously.

An objective of the present invention is to further provide a method of manufacturing an array substrate, where the manufactured array substrate has a flatter surface, a great display quality, a simplified manufacturing process, and a lowered manufacturing process cost.

An objective of the present invention is to further provide an In Cell touch control display panel where its display quality is great, and its production cost is lower, simultaneously.

To accomplish the above objectives, the present invention provides an array substrate which comprises a first substrate, a light-shielding layer disposed on said first substrate, a first insulating layer disposed on said first substrate and the light-shielding layer, an active layer disposed on said first insulating layer, a second insulating layer disposed on said first insulating layer and the active layer, a gate electrode disposed on said second insulating layer, a third insulating layer disposed on said gate electrode and the second insulating layer, a source/drain electrode and a data line disposed on said third insulating layer, a first flat layer disposed on said source/drain electrode, the data line and the third insulating layer, a touch control signal layer disposed on said first flat layer, a second flat layer disposed on said touch control signal layer and the first flat layer, a common electrode disposed on said second flat layer, a passivation layer disposed on said common electrode and the second flat layer, and a pixel electrode disposed on said passivation layer;

A first via hole is disposed on said passivation layer, the first flat layer and the second flat layer, said pixel electrode mutually contacts with the source/drain electrode by said first via hole; a second via hole is disposed on said second flat layer, said common electrode mutually contacts with the touch control signal layer by said second via hole.

Said active layer is a polysilicon layer.

Said light-shielding layer completely shields said active layer in a horizontal direction.

Said second via hole is disposed corresponding to an upper of said data line.

A material of said light-shielding layer is metal; a material of said touch control signal layer is metal.

The present invention further provides a manufacturing method of the aforementioned array substrate, which comprises the following steps of:

step 1, providing a first substrate, which bottom-to-top sequentially forms thereon a light-shielding layer, a first insulating layer, an active layer, a second insulating layer, a gate electrode, a third insulating layer, and a source/drain electrode and a data line;

step 2, forming a first flat layer on said source/drain electrode, data line and third insulating layer, forming a touch control signal layer on said first flat layer, forming a second flat layer on said touch control signal layer and first flat layer;

applying a photolithography process to etch the second flat layer and the first flat layer in a manner that a first through aperture is formed on said second flat layer and the first flat layer and with corresponding to an upper of said source/drain electrode, while a second via hole is formed on said second flat layer and with corresponding to an upper of said touch control signal layer;

step 3, forming a common electrode on said second flat layer to mutually contact with the touch control signal layer by said second via hole;

step 4, forming a passivation layer on said common electrode and the second flat layer, applying a photolithography process to etch the passivation layer where a second through aperture communicated through with said first through aperture is formed, said second through aperture and the first through aperture constitute a first via hole; and

step 5, forming a pixel electrode on said passivation layer to mutually contact with the source/drain electrode by said first via hole.

The present invention further provides an In Cell touch control display panel, which comprises an array substrate, a color film substrate disposed with corresponding to said array substrate, and a liquid crystal layer located between said array substrate and color film substrate;

Said array substrate is the aforementioned array substrate.

Said color film substrate comprises a second substrate, a black matrix disposed on said second substrate, a color resist layer disposed on said black matrix and the second substrate, a third flat layer disposed on said color resist layer, and a primary spacer disposed on said third flat layer and mutually contacting with the passivation layer on a surface of said array substrate.

Said color film substrate further comprises a sub-spacer located on the same layer where said primary spacer is located, a height of said sub-spacer is lower than a height of the primary spacer.

Said second substrate is a glass substrate; said color resist layer comprises a red color resistance, a green color resistance, and a blue color resistance.

An advantageous effect of the present invention is that: an array substrate provided by the present invention, by sequentially forming the first flat layer, the touch control signal layer, the second flat layer, the common electrode, the passivation layer, and the pixel electrode on the source/drain electrode, the data line and the third insulating layer, the architecture of which makes the touch control signal layer located under the second flat layer, would not be present in a manner that a region of a surface of the array substrate corresponding to the touch control signal layer forms protrusion, and the surface of said array substrate gets flatter so as to prevent the spacer from sliding to cause a manner of the liquid crystal cell collapsing or alignment film scratching, and thereby promote display quality; at the same time, and makes three passivation layers of conventional array substrate reduced into one passivation layer, thereby simplifying manufacturing process, lowering manufacturing process cost. The present invention provides a manufacturing method of the array substrate where the manufactured array substrate has a flatter surface, a great display quality, and a simplified manufacturing process, and a lower manufacturing process cost. The present invention provides an In Cell touch control display panel, with a great display quality as well as a lower production cost.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a cross-sectional view schematic diagram of a conventional In Cell touch control display panel where the first via hole is located;

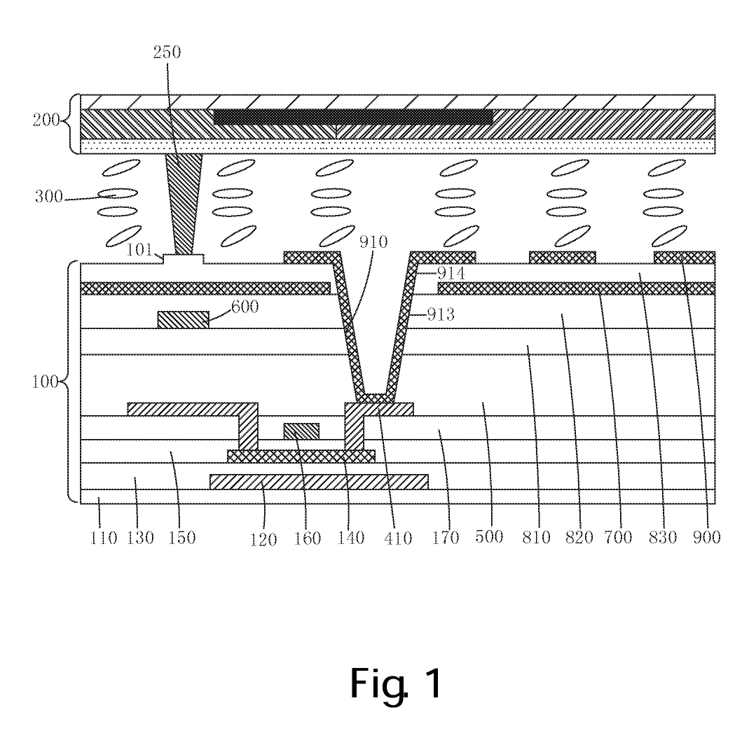

FIG. 2 is a cross-sectional view schematic diagram of the In Cell touch control display panel of FIG. 1, where the second via hole is located;

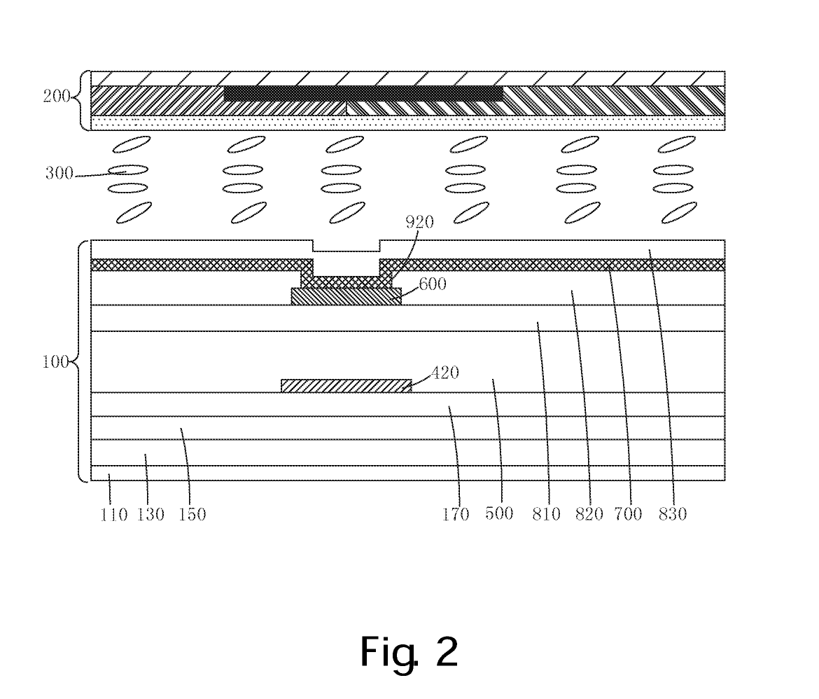

FIG. 3 is a cross-sectional view schematic diagram of a array substrate of the present invention, where the first via hole is located;

FIG. 4 is a cross-sectional view schematic diagram of the array substrate of the present invention, where the second via hole is located;

FIG. 5 is a flow chart diagram of a manufacturing method of a array substrate of the present invention;

FIG. 6 is a cross-sectional view schematic diagram of the In Cell touch control display panel of the present invention, where the first via hole of the array substrate is located; and

FIG. 7 is a cross-sectional view schematic diagram of the In Cell touch control display panel of the present invention, where the second via hole of the array substrate is located.

### DETAILED DESCRIPTION OF PREFERRED EMBODIMENTS

For better explaining the technical solution and the effect of the present invention, the present invention will be further described in detail with the accompanying drawings and the specific embodiments.

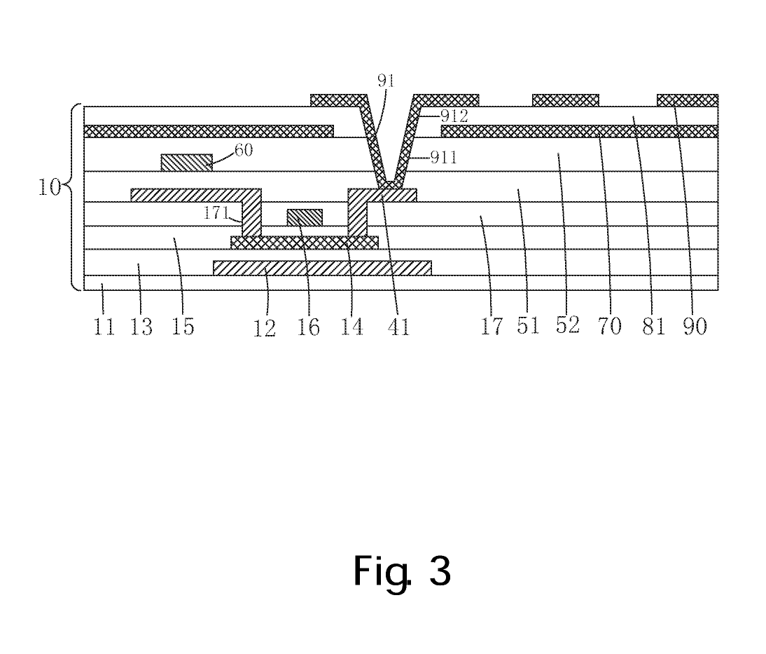

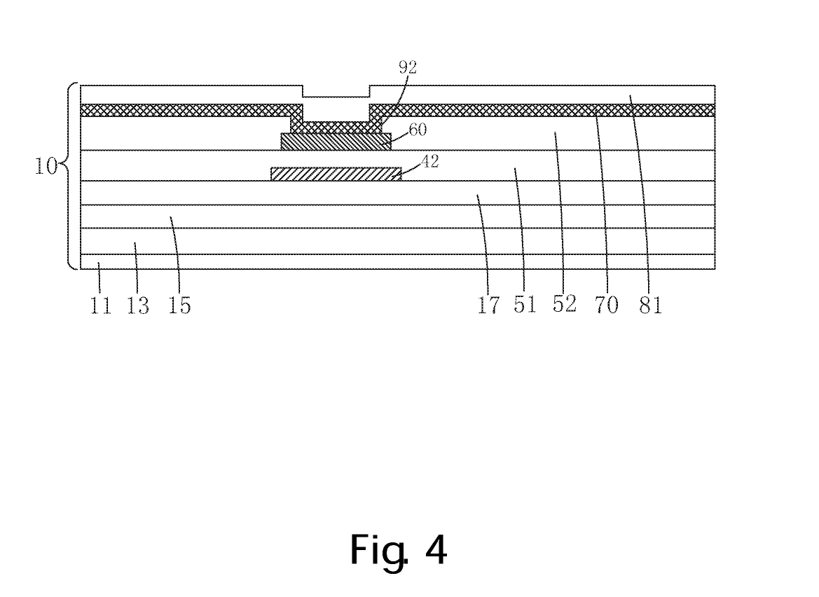

Please refer to FIG. 3 and FIG. 4, the present invention firstly provides an array substrate 10, which comprises a first substrate 11, a light-shielding layer 12 disposed on said first substrate 11, a first insulating layer 13 disposed on said first substrate 11 and the light-shielding layer 12, an active layer 14 disposed on said first insulating layer 13, a second insulating layer 15 disposed on said first insulating layer 13 and the active layer 14, a gate electrode 16 disposed on said second insulating layer 15, a third insulating layer 17 disposed on said gate electrode 16 and the second insulating layer 15, a source/drain electrode 41 and a data line 42 disposed on said third insulating layer 17, a first flat layer 51 disposed on said source/drain electrode 41, the data line 42 and the third insulating layer 17, a touch control signal layer 60 disposed on said first flat layer 51, a second flat layer 52 disposed on said touch control signal layer 60 and the first flat layer 51, a common electrode 70 disposed on said second flat layer 52, a passivation layer 81 disposed on said common electrode 70 and the second flat layer 52, and a pixel electrode 90 disposed on said passivation layer 81;

As shown in FIG. 3, a first via hole 91 is disposed on said passivation layer 81, the first flat layer 51 and the second flat layer 52, said pixel electrode 90 mutually contacts with the source/drain electrode 41 by said first via hole 91; as shown in FIG. 4, the second via hole 92 is disposed on said second flat layer 52, said common electrode 70 mutually contacts with the touch control signal layer 60 by said second via hole 92.

Specifically, a contact hole 171 is disposed on said third insulating layer 17 and the second insulating layer 15, with corresponding to an upper of two ends of said active layer 14, said source/drain electrode 41 mutually contacts with said active layer 14 by said contact hole 171.

Specifically, said first substrate 11 is a glass substrate.

Specifically, said active layer 14 is a polysilicon layer.

Specifically, said light-shielding layer 12 completely shields said active layer 14 in a horizontal direction.

Specifically, said second via hole 92 is disposed with corresponding to an upper of said data line 42.

Specifically, a material of said light-shielding layer 12 is a metal.

Specifically, a material of said touch control signal layer 60 is a metal.

Specifically, said first insulating layer 13, the second insulating layer 15, the third insulating layer 17 and the passivation layer 81 are silicon nitride (SiNx) layer, silicon oxide (SiOx) layer, or a composite layer of both of them, respectively.

Specifically, materials of said common electrode 70 and the pixel electrode 90 all are a transparent conductive metallic oxide, and preferably is indium tin oxide (ITO).

The array substrate 10 of the present invention, by sequentially forming the first flat layer 51, the touch control signal layer 60, the second flat layer 52, the common electrode 70, the passivation layer 81, and the pixel electrode 90 on the source/drain electrode 41, the data line 42 and the third insulating layer 17, such an architecture of which makes the touch control signal layer 60 located under the second flat layer 52, would not be present in a manner that a region of a surface of array substrate 10 corresponding to the touch control signal layer 60 forms protrusion, and the surface of said array substrate 10 gets flatter so as to prevent a spacer of the color film substrate from sliding to cause a manner of a liquid crystal cell collapsing or alignment film scratching after the array substrate 10 is correspondingly assembled with the color film substrate to constitute the liquid crystal cell, and thereby promoting display quality; simultaneously, and makes three passivation layers of the conventional array substrate reduced into one passivation layer, and thereby simplifies manufacturing process, lowers manufacturing process cost.

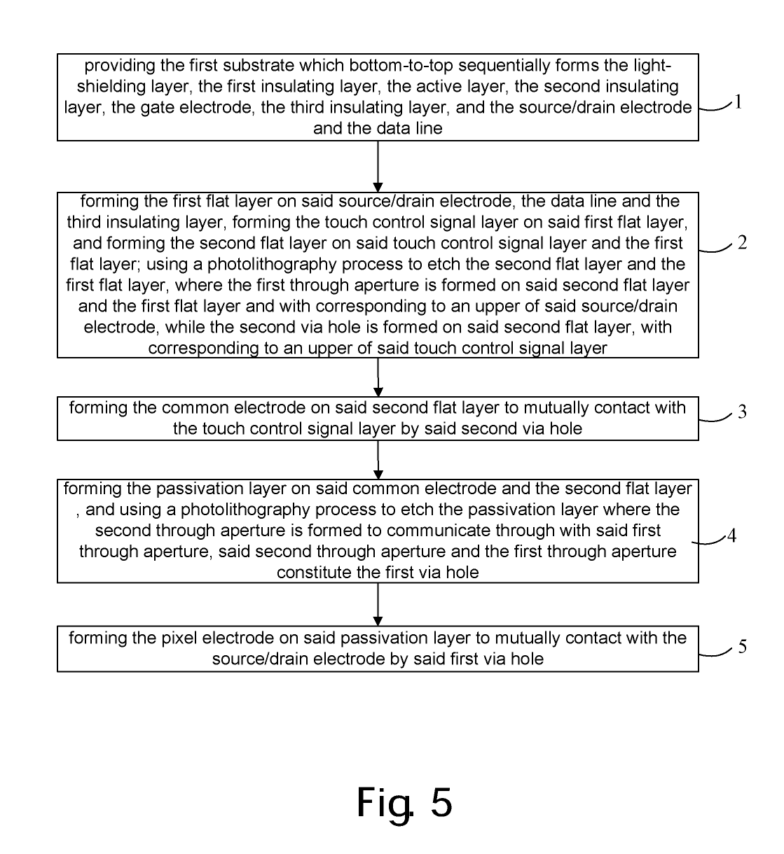

Please refer to FIG. 5, with reference to FIG. 3 and FIG. 4, based on the structure of the aforementioned array substrate 10, the present invention further provides a manufacturing method of the aforementioned array substrate 10, comprises the following steps of:

step 1, providing the first substrate 11 which bottom-to-top sequentially forms the light-shielding layer 12, the first insulating layer 13, the active layer 14, the second insulating layer 15, the gate electrode 16, the third insulating layer 17, and the source/drain electrode 41 and the data line 42 on said first substrate 11.

Specifically, in said step 1, before forming the source/drain electrode 41 and the data line 4, further having a step of etching the second insulating layer 15 and the third insulating layer 17, where the contact hole 171 is formed on the second insulating layer 15 and the third insulating layer 17, with corresponding to an upper of two ends of said active layer 14, and said source/drain electrode 41 mutually contacts with the active layer 14 by the contact hole 171.

step 2, forming the first flat layer 51 on said source/drain electrode 41, the data line 42 and the third insulating layer 17, forming the touch control signal layer 60 on said first flat layer 51, and forming the second flat layer 52 on said touch control signal layer 60 and the first flat layer 51.

using a photolithography process to etch the second flat layer 52 and the first flat layer 51, where the first through aperture 911 is formed on said second flat layer 52 and the first flat layer 51 and with corresponding to an upper of said source/drain electrode 41, while the second via hole 92 is formed on said second flat layer 52, with corresponding to an upper of said touch control signal layer 60.

step 3, forming the common electrode 70 on said second flat layer 52 to mutually contact with the touch control signal layer 60 by said second via hole 92.

step 4, forming the passivation layer 81 on said common electrode 70 and the second flat layer 52, and using a photolithography process to etch the passivation layer 81 where the second through aperture 912 is formed to communicate through with said first through aperture 911, said second through aperture 912 and the first through aperture 911 constitute the first via hole 91.

step 5, forming the pixel electrode 90 on said passivation layer 81 to mutually contact with the source/drain electrode 41 by said first via hole 91.

The manufacturing method of the array substrate 10 of the present invention, by forming sequentially the first flat layer 51, the touch control signal layer 60, the second flat layer 52, the common electrode 70, the passivation layer 81, and pixel electrode 90 on the source/drain electrode 41, the data line 42 and the third insulating layer 17, such an architecture of which makes the touch control signal layer 60 located under the second flat layer 52, would not be present in a manner that a region of the surface of the array substrate 10 corresponding to said touch control signal layer 60 forms protrusion, and the surface of said array substrate 10 gets flatter so as to prevent a spacer of the color film substrate from sliding to cause a manner of a liquid crystal cell collapsing or alignment film scratching, after the array substrate 10 is correspondingly assembled with the color film substrate to constitute the liquid crystal cell, and thereby promoting display quality; simultaneously, and makes three passivation layers manufacturing process of the conventional array substrate manufacturing process reduced into one passivation layer manufacturing process, and thereby simplifying manufacturing process, lowering manufacturing process cost.

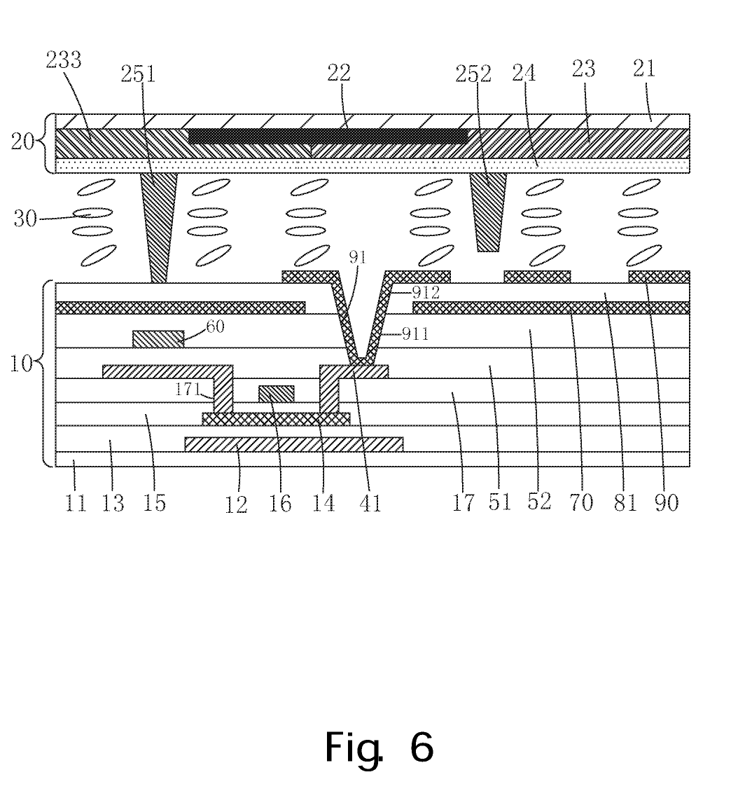

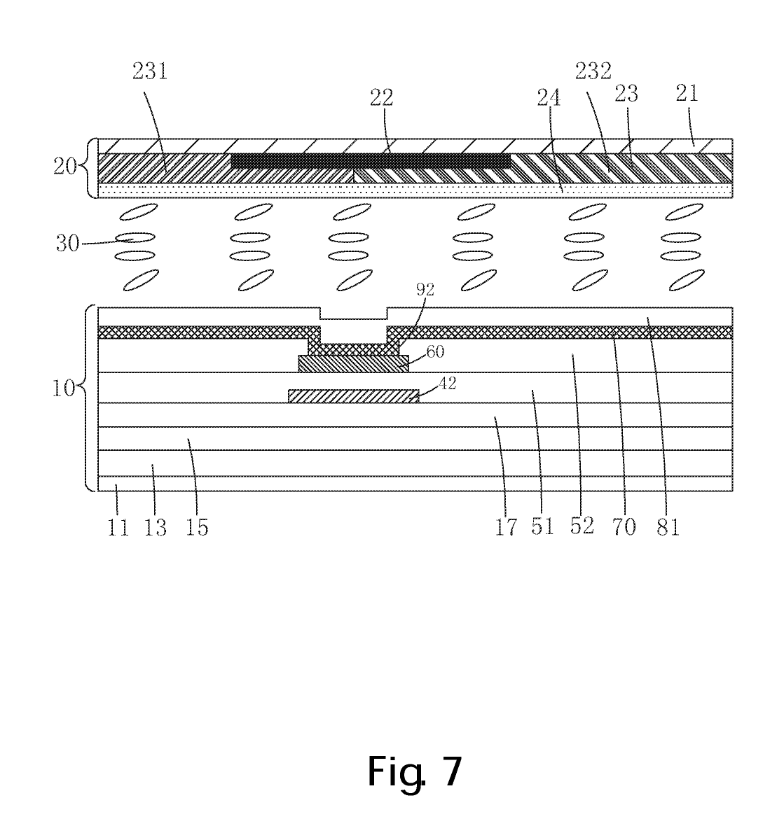

Please refer to FIG. 6 and FIG. 7, based on the aforementioned array substrate 10, the present invention further provide an In Cell touch control display panel including the aforementioned array substrate 10, which comprises the array substrate 10, and a color film substrate 20 disposed with corresponding to said array substrate 10, and a liquid crystal layer 30 located between said array substrate 10 and the color film substrate 20;

said array substrate 10 is structured as aforementioned, without description again herein.

Specifically, said color film substrate 20 comprises a second substrate 21, a black matrix 22 disposed on said second substrate 21, a color resist layer 23 disposed on said black matrix 22 and the second substrate 21, a third flat layer 24 disposed on said color resist layer 23, and a primary spacer 251 disposed on said third flat layer 24 and mutually contacting with the passivation layer 81 on the surface of said array substrate 10.

Preferably, said color film substrate 20 further comprises a sub-spacer 252 located on the same layer where said primary spacer 251 is located, a height of said sub-spacer 252 is lower than a height of said primary spacer 251 whereby a gap is formed between surfaces of both said sub-spacer 252 and said array substrate 10.

Specifically, said second substrate 21 is a glass substrate.

Specifically, said color resist layer 23 comprises a red color resistance 231, a green color resistance 232, and a blue color resistance 233.

The In Cell touch control display panel of the present invention includes the aforementioned array substrate 10 where the surface gets flatter so as to prevent a spacer of the color film substrate 20 from sliding to cause a manner of liquid crystal cell collapsing or alignment film scratching, and thereby simultaneously promotes display quality, and lowers production cost.

In conclusion of the above mention, the present invention provides an array substrate, a method of manufacturing the same and an In Cell touch control display panel. The array substrate of the present invention, by sequentially forming the first flat layer, the touch control signal layer, the second flat layer, the common electrode, the passivation layer, and the pixel electrode on the source/drain electrode, the data line and the third insulating layer, such an architecture of which makes the touch control signal layer located under the second flat layer, would not be present in a manner that the region of the surface of the array substrate corresponding to the touch control signal layer forms a protrusion, and the surface of said array substrate gets flatter so as to prevent the spacer from sliding to cause a manner of liquid crystal cell collapsing or alignment film scratching, and thereby promotes display quality; simultaneously, and makes three passivation layers of the conventional array substrate reduced into one passivation layer, and thereby simplifies manufacturing process, lowers manufacturing process cost. In the manufacturing method of the array substrate of the present invention, the manufactured array substrate gets a flatter surface, a great display quality, and a simplified manufacturing process, a lower manufacturing process cost. The In Cell touch control display panel of the present invention has a great display quality, and a lower production cost, simultaneously.

As above mentioned, in accordance with technical embodiments and technical solution of the present invention, to any persons who are ordinary skilled in the art, other related change or variances can be made which should be covered by the protected scope of the subject claims attached below by the present invention.

What is claimed is:

1. An array substrate, comprising a first substrate, a light-shielding layer disposed on said first substrate, a first insulating layer disposed on said first substrate and the light-shielding layer, an active layer disposed on said first insulating layer, a second insulating layer disposed on said first insulating layer and the active layer, a gate electrode disposed on said second insulating layer, a third insulating layer disposed on said gate electrode and the second insulating layer, a source/drain electrode and a data line disposed on said third insulating layer, a first flat layer disposed on said source/drain electrode, the data line and the third insulating layer, a touch control signal layer disposed on said first flat layer, a second flat layer disposed on said touch control signal layer and the first flat layer, a common electrode disposed on said second flat layer, a passivation layer disposed on said common electrode and the second flat layer, and a pixel electrode disposed on said passivation layer;
a first via hole being disposed on said passivation layer, the first flat layer and the second flat layer, said pixel electrode mutually contacting with the source/drain electrode by said first via hole and; a second via hole being disposed on said second flat layer, said common electrode mutually contacting with the touch control signal layer by said second via hole.

2. The array substrate as claimed in claim 1, wherein, said active layer is polysilicon layer.

3. The array substrate as claimed in claim 1, wherein, said light-shielding layer completely shields said active layer in a horizontal direction.

4. The array substrate as claimed in claim 1, wherein, said second via hole is disposed with corresponding to an upper of said data line.

5. The array substrate as claimed in claim 1, wherein, a material of said light-shielding layer is metal; a material of said touch control signal layer is metal.

6. A manufacturing method of the array substrate as claimed in claim 1, comprising following steps of:
step 1, providing the first substrate which bottom-to-top sequentially forms said first substrate the light-shielding layer, the first insulating layer, the active layer, the second insulating layer, the gate electrode, the third insulating layer, and the source/drain electrode and the data line thereon;
step 2, forming the first flat layer on said source/drain electrode, the data line and the third insulating layer, forming the touch control signal layer on said first flat layer, forming the second flat layer on said touch control signal layer and the first flat layer;
using a photolithography process to etch the second flat layer and the first flat layer, forming a first through aperture on said second flat layer and the first flat layer and with corresponding to an upper of said source/drain electrode, while the second via hole is formed on said second flat layer, with corresponding to an upper of said touch control signal layer;
step 3, forming the common electrode on said second flat layer to mutually contact with the touch control signal layer by said second via hole;
step 4, forming the passivation layer on said common electrode and the second flat layer, using a photolithography process to etch the passivation layer where said first through aperture is formed to communicate through with the second through aperture, said second through aperture and the first through aperture constitute the first via hole;
step 5, forming the pixel electrode on said passivation layer to mutually contact with the source/drain electrode by said first via hole.

7. An In Cell touch control display panel, comprising an array substrate, a color film substrate disposed with corresponding to said array substrate, and a liquid crystal layer located between said array substrate and the color film substrate;
said array substrate is the array substrate as claimed in claim 1.

8. The In Cell touch control display panel according to claim 7, wherein, said color film substrate comprises a second substrate, a black matrix disposed on said second substrate, a color resist layer disposed on said black matrix and the second substrate, a third flat layer disposed on said color resist layer, and a primary spacer disposed on said third flat layer and mutually contacting with the passivation layer on a surface of said array substrate.

9. The In Cell touch control display panel according to claim 7, wherein, said color film substrate further comprises a sub-spacer is located on the same layer where said primary spacer is located, a height of said sub-spacer is lower than a height of the primary spacer.

10. The In Cell touch control display panel according to claim 7, wherein, said second substrate is glass substrate; said color resist layer comprises a red color resistance, a green color resistance, and a blue color resistance.
